(19) United States
(12) Patent Application Publication
(10) Pub. No.: US 2002/0016842 A1
(43) Pub. Date: Feb. 7, 2002

(54) Method for charging fee for use of network resources and method and system for allotting network resources

(76) Inventor: Takashi Eki, Tokyo (JP)

Correspondence Address: VENEABLE, Post Office Box 34385, Washington, DC, 20043-9998, US

(21) Appl. No.: 09/897,431

(22) Filed: Jul. 3, 2001

(30) Foreign Application Priority Data
Jul. 21, 2000 (JP) JP2000-220673

(51) Int. Cl. G06F 15/173

(52) U.S. Cl. 709/226

(57) ABSTRACT

When an internet service provider (ISP) 1 charges web site (web site) proprietors A, B and C a fee for using their desired basic network capacity from the network resources thereof, the ISP 1 give one web site proprietor (e.g. A) a preferential option enabling one web site proprietor terminal to temporarily use a part of the basic network resources or its entirety thereof allotted to the other web site proprietor terminals (e.g. B and C) as well as a non-preferential option enabling the other web site proprietor terminals to temporarily use a part of the basic network resources or its entirety thereof allotted to the one web site proprietor terminal, and the ISP 1 charges web site proprietors the fee for their use of the basic network capacity at a premium rate/discount rate in correspondence with their purchased preferential option/non-preferential option. Accordingly, with the purchase of preferential option/non-preferential option, the basic network capacity may be substantially increased or decreased, so that the effective use of the digital network is facilitated and also, the fee for the use of the basic network capacity is made reasonable with adoption of the premium rate/discount rate in correspondence with the preferential option/non-preferential option.

### BACKGROUND OF THE INVENTION

1. Field of the Invention

The present invention relates to a method for charging a fee for the use of network resources, a method for allotting network resources, and a system for allotting network resources. More particularly, the invention relates to a method and a system which are useful for an internet service provider (referred to as “ISP” hereinafter) to allot their network resources to a plurality of web site proprietors (private persons and business enterprises), and are also useful for a call center service provider to allot their telephone network resources to a plurality of interactive voice response service proprietors (referred to as “IVR proprietor” hereinafter), and a method for charging web site proprietors or IVR proprietors the fee for the use of the digital network resources or telephone network resources.

With the recent wide spread of the internet, a lot of web sites are set up and opened by business enterprises and private persons i.e. web site proprietors. In general, however, such web site proprietors have not their own servers but make use of a rental server or a hosting service, of which the management and operation are entrusted to the ISP. Making use of the professional like the ISP, the server can come to be near the backbone network and enjoy more quick response. At the same time, it is very advantageous from the security standpoint that the server is administrated solely by the professional such as the ISP.

For the same reason, in the field of automatic interactive voice response (IVR), the IVR proprietor has neither their own server nor their own telephone network and often makes use of a rental call center, of which the management and operation are entrusted to a call center service provider.

2. Related Art

Generally, in such a system as described above, the network resources provider first makes a contract with an information provider providing necessary information for the third parties (clients) by using the network resources. -Also, the network resource provider charges the information provider the fee for the use of the network resources by the information provider according to the contents (provisions) of the contract settled therebetween.

For instance, speaking of the above example, the ISP charges the web site proprietor the fee corresponding to the digital network capacity (transmission speed, e.g. 10MB/s) of a web server and the web site proprietor provides his own web site for public reading of clients by using the capacity.

Also, in the field of the call center business, a call center service trader charges the IVR proprietor the fee corresponding to the number of the telephone networks as used by the IVR proprietor through the call center, and the IVR proprietor receives calls from various clients by the network.

Now, according to the art of this kind, both of the web site proprietor and the IVR proprietor can make use of the network resources (basic network resources) as far as its amount is within a range defined according to the contract settled initially. But when external excessive accesses, so-called an access peak has once happened even temporarily, they can not deal with the access peak any more. Therefore, in order to obviate inconvenience due to such temporary access peak, there would be no way but securing the amount of network resources capable of at least covering the access peak as expected at the time of initially settling the contract. However, even if the network resources are adequately prepared against such access peak, a considerable part of the network resources could not help being kept in the idle state in such a time zone that less or no access is made. In spite of the ineffective use of the network resources like this, the web site proprietor and the IVR proprietor have to uniformly pay the fee for all the network resources purchased according to the contract, regardless of that they work or sleep. This is apparently neither reasonable nor advantageous to the web site proprietor and the IVR proprietor as well.

An object of the invention is to provide a novel and improved method and system for allotting the network resources, which is capable of flexibly complying with the variation in the amount of the network resources the information provider terminal wishes to use, thereby enabling the network resources to be made use of effectively.

Another object of the invention is provide a novel and improved method for charging a reasonable fee for the use of the network resources, which is capable of flexibly responding to the variation in the amount of the network resources the information provider terminal wishes to use.

### SUMMARY OF THE INVENTION

In order to solve the problems as described above, according to the first aspect of the invention, there is provided a method for charging a fee for the use of network resources, which can be made use of as an accounting system between a network resource provider system providing the network resources and an information provider terminal providing the information by using the network resources. According to this method, when the network resource provider system charges the information provider terminal the fee for the use of the basic network resources allotted thereto, the network resource provider system gives one information provider terminal a preferential option enabling the information provider terminal to use a part of the basic network resources or its entirety thereof allotted to the other information provider terminal, and a non-preferential option enabling the other information provider terminal to use a part of the basic network resources or its entirety thereof allotted to the one information provider terminal, thereby charging the one information provider terminal the fee for the use of the basic network resources taking account of the premium rate/discount rate in correspondence with the preferential option/non-preferential option.

According to the method for charging the fee for the use of network resources as described above, the information provider providing the information by using the network resources is able to grasp the state of the network resources in use (for instance, the number of accesses) corresponding to the contents of the information as presented by himself, and is able to substantially increase or decrease the basic network resources by purchasing the preferential option/non-preferential option. The fee for the use of the network resources as substantially increased or decreased due to the purchase of the preferential option/non-preferential option is calculated by applying a premium rate/discount rate in correspondence with the preferential option/non-preferential option to the increased or decreased network resources, thus the fee for the use of the network resources can be reasonably charged neither too much nor too little.

Increase and decrease in the network resource capacity used for providing the information are varied mainly depending on the time zone serving the information as well as on the information contents, for instance the news and topics information are accessed a lot in the morning, the stock market information is accessed a lot in the daytime, the web site is accessed a lot for chatting at night, and so forth. Therefore, it is preferable to determine the preferential option and the non-preferential option in consideration of the time zone and the amount of the network resources as needed. The terms the amount of the network resources' indicates the network capacity in case of the digital network while it indicates the number of telephone lines in case of telephone network. The non-preferential option may be set with regard to either all or only a part of the basic network resources while the preferential option may be set without relating to the basic network resources.

Furthermore, in order to solve the problems as mentioned above, according to the second embodiment of the invention, there is provided a method for allotting the network resources of the network resource provider system to an information provider terminal providing the information by using the network resources as allotted. This method includes the steps (a) that the information provider terminal purchases a basic network resources from the network resource provider system; (b) that the information provider terminal purchases optional condition with regard to the basic network resources; and (c) that the network resource provider system allots the network resources to respective information provider terminals taking account of the basic network resources as well as the optional condition.

The above optional condition is made up of a preferential option and non-preferential option, the former enabling one information provider terminal to temporarily use a part of the basic network resources or its entirety thereof allotted to the other information provider terminal and the latter enabling the other information provider terminal to temporarily use a part of the basic network resources or its entirety thereof allotted to the one information provider terminal. In this case, the preferential option/non-preferential option may be set in consideration of the time zone and the amount of the network resources as expected to be used.

According to the method as described above, the information provider providing the information by using the network resources can grasp the state of the network resources in use (for instance, the number of accesses) in correspondence with the contents of his presented information, and is allowed to substantially increase or decrease the basic network resources by purchasing the preferential option/non-preferential option. Therefore, the network resource provider system can allot the network resources unused at the other information provider terminal to the one information provider terminal wishing to use it, thereby being able to effectively use the network resources.

The step (c) in the method for allotting the network resources as described above further includes the steps: (c1) that the network resource provider system periodically watches and judges the state of the network resources in use at the information provider terminal given the preferential option; (c2) that if it is judged, in the step (c2), that the one information provider terminal given the preferential option is using the basic network resources exceeding a predetermined ratio (threshold value), the network resource provider system allots a part of the basic network resources or its entirety thereof purchased by one or more than two of other information providers terminals given the non-preferential option, to the information provider terminal given the preferential option; and (c3) that if it is judged that the information provider terminal purchasing the preferential option no longer uses the basic resources exceeding a predetermined ratio after having allotted the network resources in the step (c2), the network resource provider system removes the allotment of the network resources in the step (c2).

According to the method as described above, the network resource provider system periodically watches and judges the state of the network resources in use at one information provider terminal given the preferential option (preferential terminal). If it is judged through the periodical watching that the one information provider terminal given the preferential option is using the basic network resources exceeding a predetermined ratio, in other words, the network resources at the preferential terminal is so congested, the network resource provider system can suitably allots the network resources of the information provider terminals given the non-preferential option (non-preferential terminal), to the information provider terminal given preferential option. Contrary to the above, if it is judged that the preferential terminal no longer uses the network resources exceeding a predetermined ratio, that is, the preferential terminal can still afford to receive the external accesses, the network resource provider system removes the allotment of the network resources from the non-preferential terminal to the preferential terminal. In this way, this method can flexibly comply with variation in the amount of network resources and realize the effective use of the network resources.

Still further, in order to solve the problems as mentioned above, according to the third aspect of the invention, there is provided a system for allotting the network resources, which can execute with ease the above-mentioned two methods, that is, the method for charging the fee for the use of the network resources and the method for allotting the network resources. This system includes a network resource provider system providing the network resources and a plurality of information provider terminals for providing the information by means of network resources allotted thereto. This network resource provider system further includes means for providing a basic network resources for the information provider terminal and giving an optional condition to the basic network resource; a memory means for storing the basic network resources allotted to each of information provider terminals and the optional condition as well; and a network control means for controlling the allotment of the network resources to each of information provider terminals with reference to the memory means.

With this system, there can be realized with ease the method for charging the fee for the use of the network resources and the method for allotting the network resources, which will bring excellent and advantageous effects as has been described so far.

### BRIEF DESCRIPTION OF THE DRAWINGS

The invention will now be described in detail with reference to the accompanying drawings, wherein the like part in each of the several figures are denoted by the like reference character, wherein:

FIG. 1 is a schematic block diagram illustrating a system for allotting digital networks according to the invention.

FIG. 2 is an example of an option table showing various basic network capacity and the optional conditions.

FIG. 3 is a flow chart describing the method for allotting digital networks.

FIG. 4 is a schematic block diagram illustrating a system for allotting telephone networks according to the invention.

In the following description, a term “network resources” is used to express the wide concept including the network for use in the communication, for instance a network capacity (communication capacity, communication band, etc) and a telephone network.

### PREFERRED EMBODIMENTS OF THE INVENTION

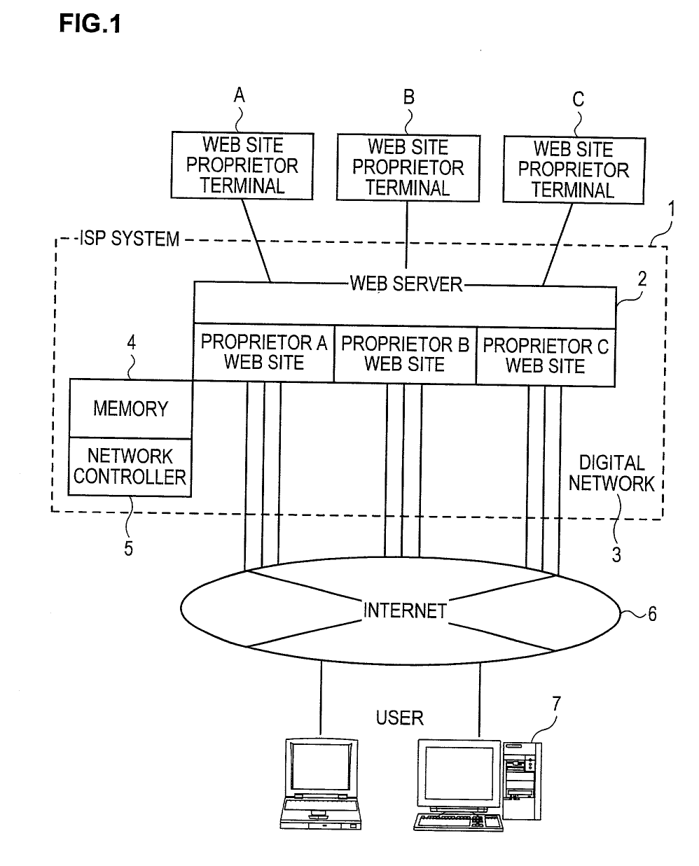

To begin with, let us start describing how the ISP providing digital networks allots the digital networks to a web site proprietor who has set up a web site and wishes to provide it for the public reading by third parties. FIG. 1 is a schematic block diagram illustrating a system for allotting digital networks to web site proprietors.

As shown in FIG. 1, the system of the ISP (referred to as “ISP system” hereinafter) 1 comprises some components such as a web server 2, digital network 3, a memory 4, and a network controller 5. The web server 2 comprises at least one computer system, a display, a keyboard, a mouse, and so forth. The ISP system 1 has the web site proprietor set up his web site within the web server 2 and enables users' terminals 7 to access to the web site through the internet 6.

In general, the terminal of the web site proprietor (referred to as “web site proprietor terminal” hereinafter) is able to edit files to be publicly on the web site, and also to upload these files to the web server 2 of the ISP system 1. In FIG. 1, only three web site proprietors' terminals A, B and C are indicated, but actually, a large number of web site proprietors' terminals are connected with the ISP system 1.

The ISP system 1 makes a contract with each of web site proprietors A, B, and C, respectively, with regard to the basic condition for the use of digital network 3. In the contract on the basic conditions, various things are stipulated, for instance the digital network capacity to be used, the contents and capacity of the web site to be opened, the termination of contract, and so forth. However, what the most concerned with, is the digital networks capacity to be used for publicly disclosing the web site to third parties. For this, the description will be not extended to the other basic conditions. In the following description, the digital network capacity that the web site proprietor terminal purchases according to the contract is referred to as “basic network capacity” hereinafter.

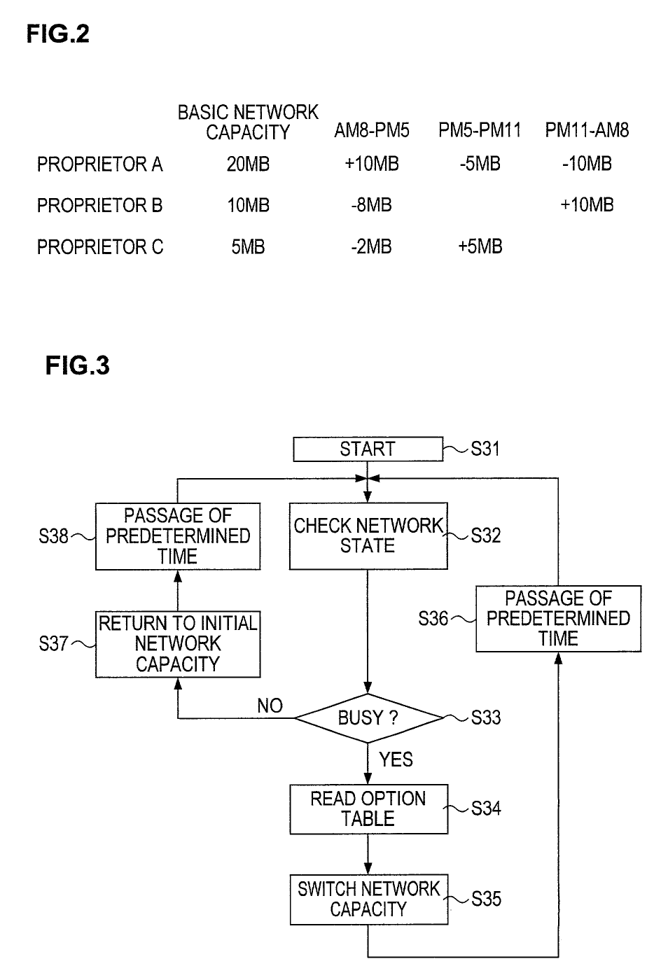

The memory 4 stores the information on the basic network capacity for each of web site proprietor terminals A, B and C. FIG. 2 shows the data in the form of a table indicating the basic network capacity for each of web site proprietor terminals A, B and C and also the optional condition as described later. This table is referred to as “option table” hereinafter. In this embodiment, it will be understood that the web site proprietor terminals A, B and C have purchased the basic network capacities of 20MB, 10MB and 5MB respectively.

The ISP system 1 charges each of the web site proprietors A, B and C the fee for the use of the basic network capacity, respectively. The fee may be charged directly to each of web site proprietors A, B and C by the ISP system 1, or indirectly by a third party such as a credit company, a financial organ, or the like. In the following description, however, whoever charges the fee for the use of the network, it may be generally referred to as “charge by the ISP system 1” regardless of the direct charging and the indirect one.

In this embodiment, when the network 3 are used for the public reading of the web site by third parties, the number of accesses to the web site is generally varied very much. In other words, the number of accesses is extremely increased or decreased depending on the contents of the web site and a specific time zone as well.

For instance, it takes place that the access to the web site provided by the web site proprietor A is extremely concentrated in the day time zone while the access to the web site provided by the web site proprietor B is concentrated in the night time zone. In the case like this, it often happens that the basic network capacity of 10MB for the web site proprietor B would be almost unused and come into the almost idle state in the day time zone. On one hand, the basic network capacity of 20MB for the web site proprietor A is used up and might come into the state no longer responding to the access due to the lack of the capacity. Contrary to this, in the night time zone, the basic network capacity of 20MB contracted by the web site proprietor A would come into the almost idle state while the basic network capacity of 10MB contracted by the web site proprietor B is used up and might be in the state no longer responding to the access due to the lack of the capacity.

In the case like this, in the day time zone, the web site proprietor A would have to wish the increase of the contracted network capacity while the web site proprietor B would have to wish the effective use of the unused network capacity. Therefore, the current embodiment includes the optional condition in the contract. With this optional condition, it becomes possible to temporarily increase or decrease the network capacity, thereby properly and timely dealing with the issue of too much network capacity and too less network capacity, and the effective use of network resources being realized.

The ISP system 1 is able to give the optional condition to the web site proprietors when charging them the fee for the use of the basic network capacity of the digital network 3. This optional condition includes of a preferential option and a non-preferential option. The preferential option is the option that allows one web site proprietor to preferentially use a part of the basic network capacity or its entirety thereof for the other web site proprietor terminal. The non-preferential option is the option corresponds to the preferential option, and allows the other web site proprietor terminal to preferentially use a part of the basic network capacity or its entirety thereof for one web site proprietor terminal.

Each web site proprietor can determine which option is to be purchased, the preferential option or the non-preferential one, in consideration of the nature of the web site, the most effective and advantageous time zone, and the required network capacity. For example, as shown in FIG. 2, a web site proprietor A may purchase the preferential option of 10MB for the time zone from 8 a.m. to 5 p.m., the non-preferential option of 5MB from 5 p.m. to 11 p.m., or the non-preferential of 10MB from 11 p.m. to 8 a.m. The web site proprietor B may purchase the non-preferential option of 8MB for the time zone from 8 a.m. to 5 p.m. and the preferential option of 10MB from 11 p.m. to 8 a.m. The web site proprietor C may purchase the non-preferential option of 2MB for the time zone from 8 a.m. to 5 p.m. and the preferential option of 5MB from 5 p.m. to 11 p.m. Each web site proprietor may purchase only the preferential option without any non-preferential option or vice versa. Due to the nature of non-preferential option, however, it should be noted that any one of the web site proprietors can not purchase the non-preferential option for the network capacity that exceeds the basic network capacity as initially contracted.

In this case, since the web site proprietor A purchases the preferential option of +10MB in the time zone from 8 a.m. to 5 p.m., he can use the maximum network capacity of 30MB i.e. 20MB (basic network capacity) +10MB (preferential option). However, he purchase the non-preferential option of −5MB in the time zone from 5 p.m. to 11 p.m. so that he can only use the network capacity of 15MB i.e. 20MB (basic network capacity) −5MB (non-preferential option) in the time zone from 5 p.m. to 11 p.m.

Accordingly, in this embodiment, taking account of the nature of the preferential option and non-preferential option, the ISP system 1 charges the web site proprietor terminal having contracted the preferential option (referred to as “preferential terminal” hereinafter) a premium fee for the use of the digital network 3, and also charges the web site proprietor terminal having contracted the non-preferential option (referred to as “non-preferential terminal” hereinafter) a discount fee for the use of the digital network 3.

That is, ISP system 1 applies the premium rate/discount rate in correspondence with the preferential option/ the non-preferential option when charging the web site proprietor terminals the fee for their use of the basic network capacity. These premium rate and the discount rate can be arbitrarily regulated by the ISP system 1.

The following is an example of calculation of the premium rate and discount rate. The premium rate of the basic network capacity cause by purchasing the preferential option can be determined according to the following formula. That is:

Premium rate=E x (F/24 hrs.) x G/H

where E: basic premium rate

F: time of preferential option applied

G: network capacity of applied preferential option

H: basic network capacity

Here, the above expression “basic premium rate” means the premium rate when purchasing the preferential option with respect to the same network capacity as the basic network capacity all the way of 24 hours. In this case, let the preferential option be allowed to purchase a network capacity exceeding the basic network capacity.

In this example (see FIG. 2), let the basic premium rate be 50% for instance. If the web site proprietor terminal (B) having purchased the basic network capacity of 10MB, has further purchased the preferential option of 10MB in the time zone of 9 hours from 11 p.m. to 8 a.m., the premium rate at that time will become 50%×(9 hrs./24 hrs.)×(10MB/10MB) 18.75%.

Furthermore, the discount rate of the basic network capacity caused by purchasing the non-preferential option can be calculated according to the following formula. That is:

Discount rate=U x (V/24 hrs.) x W/Z

where U: maximum discount rate

V: time of non-preferential option applied

W: network capacity of applied non-preferential option

Z: basic network capacity

In the formula, “maximum discount rate” means the discount rate when purchasing the non-preferential option with respect to the entire basic network capacity all the way of 24 hours. However, because of the nature of non-preferential option, it should be noted that the non-preferential option can not purchase the network capacity beyond the basic network capacity.

Now, again in the example (see FIG. 2), let the basic premium rate be 50% for instance. If the web site proprietor terminal (B) having purchased the basic network capacity of 10MB, has further purchased the non-preferential option of 8MB in the time zone of 9 hours from 8 a.m. to 5 p.m., the discount rate will become 50%×(9 hrs./24 hrs.)×(8MB/10MB)=15%.

Accordingly, with respect to the web site proprietor terminal (B) purchasing the preferential option of 10MB for 9 hours along with the non-preferential option of 8MB for 9 hours as well, the premium rate of 18.75% and the discount rate of 15% come to be applied thereto, respectively. In this case, the ISP system 1 can charge the web site proprietor terminal (B) the fee with the premium rate of 3.75% in total by offsetting the premium rate (18.75%) by the discount rate (15%) for the use of the basic network capacity. The above examples limit neither the method for calculating the premium rate and the discount rate nor the method for offsetting the premium rate by the discount rate.

As described in the above, the information relating to the optional conditions purchased by respective web site proprietor terminals is stored in the memory 4 in the form of the option table as shown in FIG. 2. As will be understood already, a plus or minus sign (+) or (−) placed before a numeral indicating the network capacity in the table shows the preferential option or the non-preferential option.

When respective web site proprietor terminals purchase the optional conditions like the above i.e. the preferential option and the non-preferential option in their desired time zone, it is needed for both options such that the sum of the network capacity corresponding to both option purchased by each web site proprietor terminal is in a well balance with respect to each time zone. If unbalanced, for instance the network capacity for total sum of the preferential option exceeds that for a total sum of the non-preferential option, there is a possibility that it might be no longer to enjoy the preferential option, when a lot of accesses are concentrated on the web site opened at the preferential option terminal.

In FIG. 2, in the time zone from 8 a.m. to 5 p.m., the web site proprietor terminal A purchases the preferential option of +10MB, the web site proprietor B does the non-preferential option of −8MB, and the web site proprietor C also does the non-preferential option of −2MB, thus being well balanced (i.e. +10MB−8MB−2MB=0). In the similar manner, it will be clearly seen that the balance is well kept in the other time zones.

Of course, if the network capacity of the ISP system 1 can sufficiently afford to share the total amount of the basic network capacities declared by all the web site proprietor terminals, there would be no need for such balance issue to be considered. Contrary to this, even if the network capacity of the ISP system 1 can not so afford to do, it would not be so difficult to keep a balance between the preferential option and the non-preferential option as a lot of the web site proprietor terminals exist in this system, actually. Furthermore, in the time zone in which a number of the web site proprietor terminals wish to contract the preferential option (or non-preferential option), the preferential option and the non-preferential option may be balanced with ease by make the premium rate for the preferential option and the discount rate for the non-preferential option larger (smaller).

Next a method for allotting the digital network 3 to the web site proprietor terminals will be described, with reference to a flow chart as shown in FIG. 3. The network controller 5 of the ISP system 1 monitors the state of the digital network 3 and switches, the allotment of the digital network 3 according to the option table stored in the memory 4.

First, a web site is opened in the web server 2 (step S31). The network controller 5 then watches the state of the digital network 3 (step S32), and checks the state of the basic network capacity used by the web site proprietor terminals (step S33). In this step S33, it is enough to check the state of the basic network capacity at each web site proprietor terminal purchasing the preferential option. If the basic network capacity for a certain preferential terminal is used exceeding a certain ratio, the option table for the terminal is read out from the memory 4 (step S34). Then, the controller 5 switches, according to the option table, the digital network 3 allotted to non-preferential terminals to the preferential terminal (step S35).

Here, the term “a certain ratio”, in the step S35, as the condition for allotting the digital network 3 carried out in compliance with the preferential option, can be used as a predetermined threshold value. In other words, the threshold value may be such as “80% or more of the basic network capacity,” “90% or basic network capacity,” or “100% of the basic network capacity.” For instance, the threshold value like this is preferably determined so as to ensure the digital network 3 that will not cause any delayed access to the web site, by statistically analyzing the state of the digital network 3.

For instance, it is assumed that the delayed access to the objective web site never may arise when more than 90% of the digital network 3 of the basic network capacity is used. In this case, in an example of the option table shown in FIG. 2, if the digital network 3 of more than 18MB among the basic network capacity 20MB at the preferential terminal A is used in the time zone from 8 a.m. to 5 p.m., a part of the basic network capacities or its entirety thereof at the non-preferential terminals B and/or C is switched to be allotted to the preferential terminal A. For instance, if it is judged that the delayed access would be solved by allotting the network capacity of 5MB to the preferential terminal A, the network capacity of 5MB can be switched to be allotted to the preferential terminal A from the basic network capacity of non-preferential terminals B and/or C.

In this case, since the ratio between the non-preferential network capacities of the non-preferential terminals B and C is −8MB:−2MB=4:1, the total network capacity of the 5MB consisting of the 4MB network capacity from the non-preferential terminal B and the 1MB network capacity from the non-preferential terminal C can be allotted to the preferential terminal A.

Observation of the state of the digital network 3 is periodically carried out by the network controller 5. That is, after the passage of a predetermined period of time for observation, the observation step moves from step S36 to the step S32 to again judge the state of the digital network 3.

In step S33, despite that a part of the network capacities of the non-preferential terminals B and C or its entirety thereof are still allotted to the preferential terminal A, if the basic network capacity of the preferential terminal A is no longer used exceeding the above-mentioned certain ratio, this temporary allotment to the preferential terminal A is terminated and returned to the initial network capacity allotment for the preferential terminal A (step S37). Then, after the passage of a predetermined period of time (step S38), the procedure moves from step S38 to the step S32 to again judge the state of the digital network 3.

As has been discussed in detail, according to the embodiment, web site proprietors (information provider) A, B and C presenting the information through their web sites can substantially increase or decrease their basic network capacities by making use of the preferential option and the non-preferential option. Therefore, the ISP system 1 can allot the network resources not in use of one information provider terminal to the other information provider terminal wishing to use them, thereby being able to facilitate the effective use of the network resources.

Furthermore, the substantial increase or decrease of the basic network capacity can be obtained by purchasing the preferential option/non-preferential option, so that the premium rate/discount rate become applicable to such increase or decrease of the basic network capacity in correspondence with the preferential option/nonpreferential option. Therefore, it becomes possible for the information providers A, B and C to ensure the necessary amount of the network capacity and at the same time, to make use of the digital network 3 at a reasonable rate.

The method for charging the fee for the use of network resources and the method and system for allotting network resources according to the invention have been described in detail, however, the invention is not to be limited by those embodiments. It is apparent that one ordinary skilled in the art can make various changes and modifications within the scope of the claim, and it is understood that those changes and modifications are covered by the technical scope of the invention.

For example, the invention is not limited to the allotment of the digital networks between the ISP trader supplying the digital networks and the web site proprietor setting up his own web site to provide information by using the digital network allotted thereto.

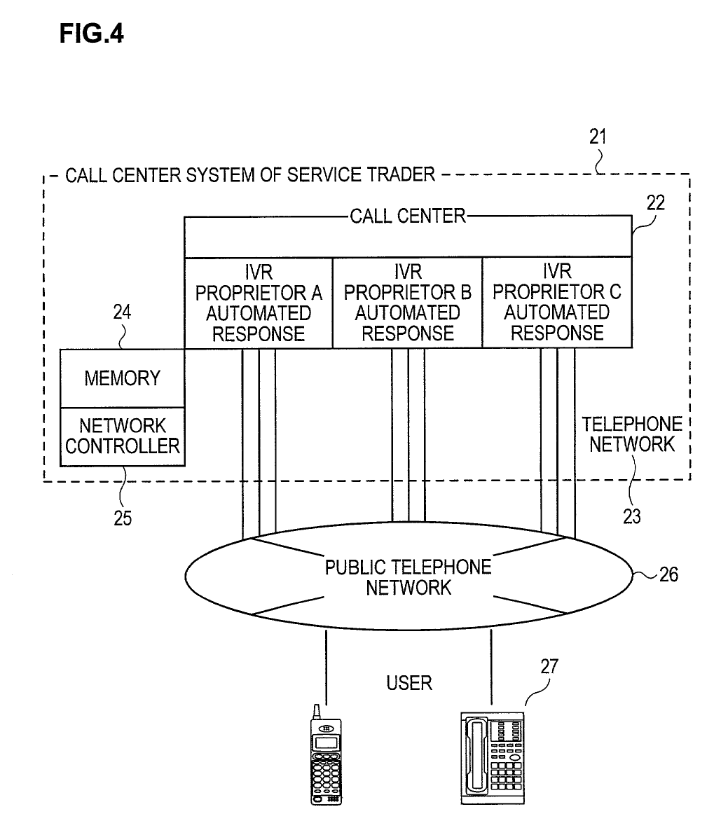

For instance, the invention is still applicable to the case where a call center service trader (e.g. telemarketing trader) having telephone network resources, allots and supplies its telephone network resources to the interactive voice response service (IVR) trader. FIG. 4 is a schematic block diagram showing such a system.

As shown in FIG. 4, the call center service trader sets up a call center system 21 and provides its service for the IVR proprietors A, B and C by using a call center 22. The call center system 21 further includes components such as telephone network 23, a memory 24, and a network controller 25. The call center service trader makes IVR proprietors A, B and C set up their terminals installed with an automatic response program in the call center 22 and provides the telephone service for users 27 through the public telephone network 26.

A method for charging the call fee for the use of the telephone network, a method for allotting the telephone network, and a system for doing the same are substantially identical to those which have been described in connection with the above embodiment, so that the detailed description will be omitted.

In the above embodiment, it is explained that the optional condition can be set with regard to the time zone and the amount of the network resources. However, the invention is not limited to this and the optional condition may be set based on other concepts. For example, in case of the tourist resort information or the like, the amount of the network resources the information provider wishes to use is affected by the weather as the case may be. Therefore, the optional condition may be set corresponding to the weather. For instance, it may be possible to designate and set (sell) a specific day option such as a fine day option capable of preferentially using network resources on a fine day, a rainy day option allowing the preferential use of the network resources on the rainy day, and so forth.

Furthermore, in case of the information such as the disaster information, the prompt report on the election result and so forth which are desired to be widely and promptly delivered, the information provider is abruptly urged to increase the amount of the network resources as the case may be. To comply with this need, it may be possible to set up (sell) an emergency option allowing the preferential use of the network resources for delivering the disaster information, election option capable of preferentially using the network resources for the prompt report on the election result, and so forth.

What is claimed is:

1. A method for charging a fee for the use of network resources, which can be made use of between a network resource provider system providing the network resources and an information provider terminal providing the information by using said network resources,
wherein when said network resource provider system charges one information provider terminal a fee for the use of the basic network resources allotted thereto, said network resource provider system gives said one information provider terminal a preferential option enabling said one information provider terminal to use a part of the basic network resources or its entirety thereof allotted to the other information provider terminal and/or a non-preferential option enabling other information provider terminal to use a part of the basic network resources or its entirety thereof allotted to said one information provider terminal, thereby charging said one information provider terminal the fee for the use of the basic network resources taking account of the premium rate/discount rate in correspondence with the said preferential option/non-preferential option.

2. A method for charging a fee for the use of network resources as claimed in claim 1, wherein said preferential option/non-preferential option are determined on the basis of a time zone as well as on the amount of network resources, and said premium rate/discount rate are determined based on the time zone as well as on the amount of network resources of said preferential option/non-preferential option.

3. A method for allotting the network resources supplied by a network resource provider system to an information provider terminal using said network resources, said method comprising the steps:
(a) said information provider terminal purchases a basic network resources from said network resource provider system;
(b) said information provider terminal purchases an optional condition with regard to said basic network resources; and
(c) said network resource provider system allots said network resources to each information provider terminal according to said basic network resources and said optional condition as well.

4. A method for allotting the network resources as claimed in claim 3, wherein said optional condition includes a preferential option enabling one information provider terminal to temporarily use a part of the basic network resources or its entirety thereof allotted to the other information provider terminal and a non-preferential option enabling the other information provider terminal to temporarily use a part of the basic network resources or its entirety thereof allotted to said one information provider terminal.

5. A method for allotting the network resources as claimed in claim 4, wherein said preferential option and said non-preferential option may be determined on the basis of a time zone and on the amount of network resources.

6. A method for allotting the network resources as claimed in claim 4, wherein said step (c) further includes the steps:
(c1) said netw ork resource provider system judges the state of the network resources at said one information provider terminal given said preferential option;
(c2) when the status of the network resource for said one information provider terminal given the preferential option exceeding a predetermined ratio, said network resource provider system allots a part of basic network resources or its entirety thereof purchased by other information provider terminals given the non-preferential option, to said one information provider terminal; and
(c3) when the status of said one information provider terminal purchasing the preferential option no longer uses said basic resources exceeding a predetermined ratio after having allotted the network resources in said step (C2), said network resource provider system releases the allotment of the network resources in said step (c2).

7. A system for allotting network resources including a network resource provider system providing the network resources and a plurality of information provider terminals providing the information, wherein said network resource provider system comprising:
means for giving a basic network resource to said information provider terminals and giving an optional condition to said basic network resource;
memory means for storing said basic network resources allotted to each of said information provider terminals and said optional condition as well; and
a network resource control means for controlling the allotment of said network resources to each of said information provider terminals with reference to said memory means.

8. A system for allotting network resources as claimed in claim 7, wherein said optional condition includes a preferential option enabling one information provider terminal to temporarily use a part of the basic network resources or its entirety thereof allotted to the other information provider terminal and a non-preferential option enabling the other information provider terminal to temporarily use a part of the basic network resources or its entirety thereof allotted to said one information provider terminal.

9. A system for allotting network resources as claimed in claim 8, wherein said preferential option and said non-preferential option may be determined on the basis of a time zone and on the amount of network resources.

10. A system for allotting network resources as claimed in claim 7, further comprising:
a monitoring means for monitoring the status of the network resources at said information provider terminal, wherein said network resource control means controls the allotment of said network resources to each of said information provider terminals based on the monitoring result.

11. A system for allotting network resources as claimed in claim 10,
wherein when said network resource control means judges, that the status of the basic network resources for said one information provider terminal given the preferential option exceeds a predetermined ratio, said network resource control means allots a part of a basic network resources or its entirety thereof purchased by other information provider terminals given the non-preferential option, to said one information provider terminal; and
when the status of said one information provider terminal given the preferential option no longer uses said basic resources exceeding a predetermined ratio after having allotted the network resources to said information provider terminal, said network control means releases the allotment of the network resources to said one information provider terminal.
